(19) United States
(12) Patent Application Publication
(10) Pub. No.: US 2022/0413993 A1
(43) Pub. Date: Dec. 29, 2022

(54) ANOMALY DETECTION OF FIRMWARE REVISIONS IN A NETWORK

(71) Applicant: Cox Communications, Inc., Atlanta, GA (US)

(72) Inventors: Serge Farinas, Atlanta, GA (US); Taewoon Kong, Atlanta, GA (US); Bradley Demerich, Atlanta, GA (US)

(73) Assignee: Cox Communications, Inc., Atlanta, GA (US)

(21) Appl. No.: 17/362,788

(22) Filed: Jun. 29, 2021

(51) Int. Cl. G06F 11/36; G06N 3/08; G06N 3/04

(52) U.S. Cl. CPC G06F 11/3616; G06N 3/088; G06N 3/0472

(57) ABSTRACT

This disclosure describes systems, methods, and devices related to anomaly detection of CPE firmware revisions. A method may include collecting metrics data for a plurality of customer-provided equipment (CPE) models over a window of time; training a first autoencoder for a first CPE model of the plurality of CPE models using at least a portion of the metrics data to detect anomalies within a plurality of firmware versions of the first CPE model; identifying, using the first autoencoder, that a first firmware version of the plurality of firmware versions is anomalous across a first time series; and storing data indicating that the first firmware version of the plurality of firmware versions is anomalous across the first time series. Metrics data may include one or more of interactive voice response (IVR) session data; calls handled data; and truck schedule data.

### TECHNICAL FIELD

This disclosure generally relates to systems and methods for performing anomaly detection of customer premises equipment (CPE) firmware revisions. In some embodiments, the disclosure may more specifically relate to anomaly detection on Data Over Cable Service Interface Specification (DOCSIS) networks.

### BACKGROUND

A wide variety of network service providers may establish communication networks to connect customer-premises equipment or customer-provided equipment (CPE) to one or more networks such as DOCSIS networks. Network service providers may simultaneously support several different CPE firmware revisions. In some instances, networks (e.g., DOCSIS networks) may experience impairments, outages, and/or intermittent disconnection issues, which may result in reduced user experience. Typically such network issues may be identified after the issues have occurred by users (e.g., customers) informing (e.g., by calling, emailing, or the like) the network service providers about the issues. Impairments, outages, and/or intermittent disconnections issues may be attributable to various causes. In many cases, it is difficult to conclusively identify whether impairments, outages, or other issues are attributable to a specific CPE firmware revision. The network service providers may dispatch technicians to a local location where an issue has occurred to determine whether the issue is originated from services with the network, with an individual CPE, with a specific CPE firmware revision, or a myriad of other possible causes. Therefore, the conventional system and methods are time-consuming and are incapable of identifying network issues timely, efficiently, and accurately.

### BRIEF DESCRIPTION OF THE DRAWINGS

FIG. 1 illustrates an example system for anomaly detection of customer premises equipment (CPE) firmware revisions, in accordance with one or more example embodiments of the present disclosure.

FIG. 2A illustrates example graphs of metrics evaluated by the outage detection systems of FIG. 1, in accordance with one or more embodiments of the present disclosure.

FIG. 2B illustrates example graphs of metrics evaluated by the outage detection systems of FIG. 1, in accordance with one or more embodiments of the present disclosure.

FIG. 3 illustrates an example computing environment in which anomaly detection of CPE firmware revisions may be implemented in the context of a computing resource service provider (e.g., cloud provider) setting, according to at least one embodiment.

FIG. 4 shows an illustrative example of a process 400 for anomaly detection of CPE firmware revisions, in accordance with one or more example embodiments of the present disclosure.

FIG. 5 illustrates a block diagram of an example machine upon which any of one or more techniques (e.g., methods) may be performed, in accordance with one or more example embodiments of the present disclosure.

Certain implementations will now be described more fully below with reference to the accompanying drawings, in which various implementations and/or aspects are shown. However, various aspects may be implemented in many different forms and should not be construed as limited to the implementations set forth herein; rather, these implementations are provided so that this disclosure will be thorough and complete, and will fully convey the scope of the disclosure to those skilled in the art. Like numbers in the figures refer to like elements throughout. Hence, if a feature is used across several drawings, the number used to identify the feature in the drawing where the feature first appeared will be used in later drawings.

### DETAILED DESCRIPTION

Example embodiments described herein provide certain systems, methods, and devices for anomaly detection of customer premises equipment (CPE) firmware revisions. The following description and the drawings sufficiently illustrate specific embodiments to enable those skilled in the art to practice them. Other embodiments may incorporate structural, logical, electrical, process, algorithm, and other changes. Portions and features of some embodiments may be included in, or substituted for, those of other embodiments. Embodiments set forth in the claims encompass all available equivalents of those claims.

Multiple-system operators (MSOs) operate multiple customer services, such as broadband and television. Some MSOs may use a variety of systems to deliver services, such as optical networks, networks using the Data Over Cable Service Interface Specification (DOCSIS), and the like.

Monitoring different types of data for different services may be challenging. For example, MSOs and other service providers may rely on different metrics to identify performance data anomalies (e.g., indicative of service outages), such as a call-based metrics to detect when a call volume significantly deviates from an expected call volume at a particular time, a customer service call metric to detect when a significant number of customers within a geographic area make customer service calls at a particular time, a modem-based detection metric to detect when a percentage of modems lose a connection, and so on.

System outages and other impairments may occur at many locations. For example, an outage or impairment may be system-wide, market-wide, or at the node level. In some cases, an outage or impairment may be related to a specific CPE or CPE firmware revision. MSOs and other service providers may provide service to a variety of customer premises equipment (CPE), where many CPE (e.g., the one or more CPE of 500 customers) may be in communication with a respective node, and a system may include many nodes. For example, a node may provide service to all the CPE of a neighborhood. Fiber optics and other connections may deliver data to a node, and coaxial cable or other connections may deliver the data the “last mile” from the node to the CPE. Customers may experience other types of network impairments beyond network outages, such as increased latency.

Sometimes, service outages or impairments affecting different CPE serviced by one node or across multiple nodes may be related. In some cases, outages or other types of network impairments may be related to CPE firmware revisions. It is not always possible to fully replicate a production environment, and it may be possible that a CPE firmware version that is tested and validated in a test environment does not perform identically in a production environment. This may, in rare instances, lead to cases where network impairments experienced by end-users may be attributable to a CPE firmware. However, it may be difficult to determine when this is the case, as the general assumption may be that CPE firmware revisions that pass all validation tests and operate correctly within a test environment will also do so when deployed to end-users.

There is therefore a need for enhanced anomaly detection of CPE firmware revisions.

In one or more embodiments, a system (e.g., a MSO system that provides different services to multiple customers) may consolidate metrics (e.g., transaction data) and use the collected metrics to train a machine-learning model to perform anomaly detection, and then use the trained machine-learning model to identify anomalies within various CPE firmware versions of a network, such as a DOCSIS network.

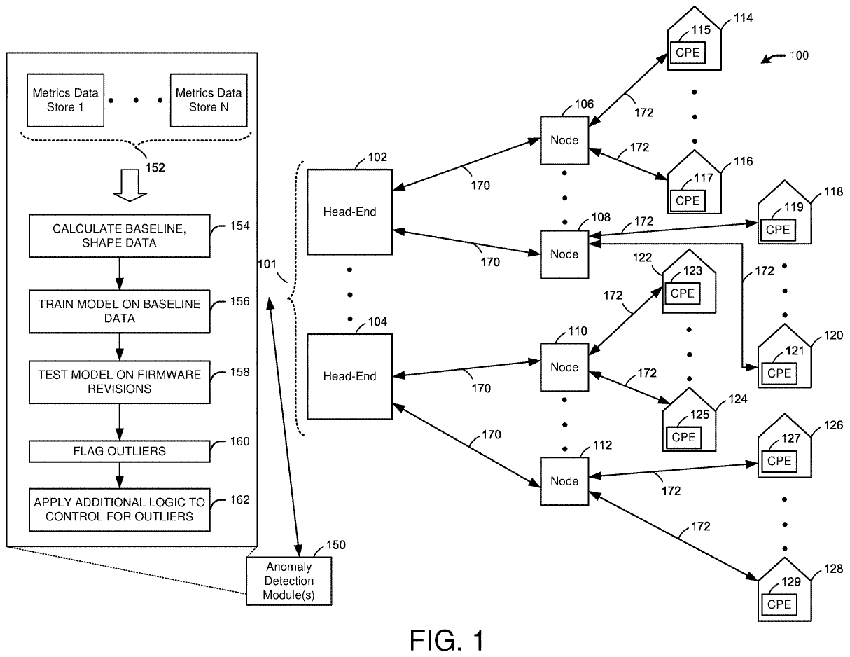

A system performing anomaly detection may query transformed data. Transformed data may be generated by obtaining source data from one or more metrics data stores such as those described in connection with FIG. 1 and perform an extract, transform, and load (ETL) procedure on the data. CPE and/or firmware revision counts may be obtained from source data. The source data may be aggregated by date and/or media access control address (MAC address or MAC). The processing workflow may furthermore join product and customer id number (e.g., customer key) on MAC. A join of various metrics of interest on customer id number (e.g., customer key) may then be performed. For example, a join of interactive voice response (IVR) session data; calls handled data; and trucks data may be joined on customer id number (e.g., customer key) to produce a final table that is aggregated by date, vendor, model, and firmware version. The final table may be an ETL target table that is model ready. In various embodiments, the model-ready data is stored in a table organized in columns or fields and may include one or more of (including combinations of): date/time of record (e.g., event); site identifier or information; node identifier; CPE vendor; CPE mode; CPE firmware version; product type (e.g., whether the product is used for data, video, telephone, or other network functionality); cable modem termination system (CMTS) reset information; loss of synchronization between CMTS and device information; t1 error information (e.g., modem has not received upstream channel descriptor); t2 error information (e.g., modem did not receive broadcast maintenance opportunity); t3 error information (e.g., modem has sent ranging requests but not received ranging response from CMTS); t4 error information (e.g., modem has not received broadcast maintenance opportunity in which to transmit ranging request); count of devices on network; count of IVR transactions; count of calls handled; count of tech support home technician trucks scheduled; count of tech support home technician trucks rolled to customer. The model-ready data or a portion thereof may be used as baseline data.

The anomaly detection module may then train a model on baseline data. As discussed above, the baseline data may be aggregated by date and firmware. The model may be an autoencoder that is trained in an unsupervised manner. In various embodiments, baseline data for all firmware revisions of a particular CPE model may be used to train an autoencoder. In some embodiments, some firmware revisions (e.g., outliers) may be excluded from the baseline data used to train the model.

Once a suitable model has been trained for a CPE mode, the model may be used to flag outlier points. Outlier points may be flagged by computing mean absolute error (MAE) losses for each CPE firmware revision associated with the CPE model. In various embodiments, a probability density function or curve is determined based on these computed losses. The PDF may be used to determine a CDF to determine an outlier threshold. The outlier threshold may refer to the MAE loss value that corresponds to a particular CDF percentile, such as the 99^{th} percentile, 99.5th percentile, or any other suitable percentile for identifying anomalous behavior. CPE firmware revisions that exceed the outlier threshold may be flagged as outliers. A time series may be generated for each CPE firmware revision.

In some cases, the anomaly detection model may perform additional logic to control for outliers. For example, if anomalous behavior is detected on only one day over an extended time window (e.g., 3 months) it may be unhelpful to surface the anomaly or there may be lower confidence, statistically speaking, that the firmware revision has a problem. In some embodiments, outliers are retained if they are in close temporal proximity to other outliers. For example, if 2-of-3 days are outliers, then the outliers may be retained; else, the outliers are discarded as isolated cases.

Benefits of the anomaly detection systems described in greater detail below include faster identification of potentially problematic CPE firmware revisions that may be used to more quickly identify the root cause of outages or impairments, more quickly deploy mitigations for said outages or impairments, and provide for greater end-user network reliability. Various problems described herein, including the detection of anomalous CPE firmware revisions, are rooted in computer technology.

The above descriptions are for purposes of illustration and are not meant to be limiting. Numerous other examples, configurations, processes, etc., may exist, some of which are described in greater detail below. Example embodiments will now be described with reference to the accompanying figures.

FIG. 1 illustrates an example system 100 for anomaly detection of CPE firmware revisions, in accordance with one or more example embodiments of the present disclosure.

Referring to FIG. 1, the system 100 may include head-ends 101 (e.g., head-end 102, head-end 104), which may refer to a facility and/or devices for receiving and processing signals, and distributing content (e.g., television content) to nodes (e.g., hybrid fiber-coaxial—HFC—nodes such as node 106, node 108, node 110, node 112), and ultimately to CPE of customer homes (e.g., home 114 with CPE 115 serviced by node 106, home 116 with CPE 117 serviced by node 106, home 118 with CPE 119 serviced by node 108, home 120 with CPE 121 serviced by node 108, home 122 with CPE 123 serviced by node 110, home 124 with CPE 125 serviced by node 110, home 126 with CPE 127 serviced by node 112, home 128 with CPE 129 serviced by node 112). The nodes may include taps, amplifiers, splitters, and the like to receive signals from the head-ends, and to provide content in the form of signals to the CPE of many homes. The nodes may collect metrics for the respectively serviced CPE, and may provide the metrics to the head-ends and/or to record the metrics in one or more metrics data stores 152, which may be implemented in a head-end or in a remote device (e.g., a service center, a cloud-based environment, or the like).

Still referring to FIG. 1, the one or more anomaly detection modules 150 may include or have access to metrics data stores 152 (e.g., metrics data store 1-metrics data store N), any of which may store transaction data that may be used to detect anomalies at the CPE level, node level, head-end level, or the like. For example, the one or more anomaly detection modules 150 may train one machine-learning models (e.g., autoencoders) using the collected metrics and identify anomalies (e.g., indicative of service outages) associated with specific CPE firmware revisions. One or more anomaly detection modules 150 may rely on various types of metrics to detect anomalies, including call-based detection metrics to detect when a call volume significantly deviates from an expected call volume at a particular time, customer service call metrics to detect when a significant number of customers within a geographic area make customer service calls at a particular time, modem-based detection metrics to detect when a percentage of modems lose a connection, and the like. The one or more metrics data stores 152 may record respective metrics indicative of the occurrence of outage events (e.g., because respective cable system outage criteria is or is not satisfied), a time when the events occur, and a location of the events (e.g., a customer address, a node, a head-end, etc.) where applicable.

Still referring to FIG. 1, the one or more anomaly detection modules 150 may ingest output (e.g., outage or impairment) data from the one or more metrics data stores 152, which may include some indicator of the location of detected events, the times when the events started, and the times when the events ended. The one or more anomaly detection modules 150 may perform anomaly detection of CPE firmware revisions on a predetermined schedule (e.g., daily) and/or in response to certain network conditions (e.g., one or more metrics exceeding a threshold). In particular, as shown, at step 154, the one or more anomaly detection modules 150 may receive metrics data from the one or more metrics data stores to calculate baseline, shape data. The one or more metrics data stores may each represent a different type of metrics data. Metrics stored may include one or more of (including combinations of): edge health poll data; customer equipment information (e.g., customer id number and product provisioning); customer information; customer location information; work order data; work order billing information; work order type information; work order status information; site information; optical node information; call information; exit point dimension table; IVR session data; IVR session transactions; and more. Counts or rates of various metrics may be stored. The one or more metrics data stores 152 may store data in a source data format which is subject to an extract, transform, and load (ETL) procedure that shapes the data for modelling. The ETL target data may be generated from the source data (e.g., one or more metrics data stores) and stored in a separate data store for ingestion by a machine-learning model. The ETL target data may be stored in a table with columns or fields for one or more of (including combinations of): date/time of record (e.g., event); site identifier or information; node identifier; CPE vendor; CPE mode; CPE firmware version; product type (e.g., whether the product is used for data, video, telephone, or other network functionality); cable modem termination system (CMTS) reset information; loss of synchronization between CMTS and device information; t1 error information (e.g., modem has not received upstream channel descriptor); t2 error information (e.g., modem did not receive broadcast maintenance opportunity); t3 error information (e.g., modem has sent ranging requests but not received ranging response from CMTS); t4 error information (e.g., modem has not received broadcast maintenance opportunity in which to transmit ranging request); count of devices on network; count of IVR transactions; count of calls handled; count of tech support home technician trucks scheduled; count of tech support home technician trucks rolled to customer. Rates and counts of the various columns described may be utilized. In various embodiments, the baseline data is shaped by excluding certain source data that is determined to be outliers. For example, across an aggregate data set (e.g., all firmware versions for a particular CPE model), outlier revisions may refer to those that exceed a certain statistical threshold, such as three standard deviations, and may be omitted from the training step, as described below.

At step 156, the one or more anomaly detection modules 150 may train one or more models on baseline data. As noted above, baseline data may use ETL target data, or a portion thereof, as training set data. In various embodiments, training one or more models on baseline data comprises training a machine-learning model for each CPE model that was identified in the ETL target data. Accordingly, there may be single machine-learning model that is generated for a plurality of firmware versions for a particular CPE model. In various embodiments, the ETL target data is used to train one or more autoencoders. An autoencoder may refer to a non-limiting illustrative example of a type of machine-learning model that may be trained. An autoencoder may refer to a type of feedforward, non-recurrent neural network with an input layer, one or more hidden layers, and an output layer. An autoencoder may comprise two parts, an encoder and a decoder. The encoder of an autoencoder may comprise an input layer and one or more hidden layers. Inputs are provided to the input layer of an encoder to produce a code, which may also be referred to as a latent variables or latent representation. In other words, the encoder maps a set of input variables into a code. The decoder may perform the opposite function, and map the code to a reconstruction of the input. An autoencoder may be trained to accept a set of inputs and approximately generate a set of outputs to match the set of inputs. An autoencoder may be trained in an unsupervised manner. The training of an autoencoder may involve refining weights and biases within the encoder. Weights and biases may be initialized randomly and then updated iteratively through backpropagation. Weights and biases for the decoder may be updated through backpropagation as well. The weights for encoder and decoder portions of the autoencoder may be different/unrelated. Inputs to the autoencoder may include tuples of data that include some or all of the ETL target data fields described above. Input data may be provided over a window of time—for example, the preceding 90 days.

ETL target data may be used to train one autoencoder per CPE model, according to at least one embodiment. The one or more anomaly detection modules may test 158 one or more trained models on firmware revisions. For example, in at least one embodiment, during the training stage, a CPE model-specific autoencoder is generated for each CPE model that is found in the ETL target data. CPE models may have several different firmware revisions. The trained autoencoders may be used to test whether specific firmware revisions for a CPE model exhibit anomalous behavior using the CPE model-specific autoencoder. Testing firmware revisions may involve a model fitting process where trained models are fit to firmware data (e.g., test data). Firmware revisions with a bad fit will have observed values with high error relative to the model's predictions. In various embodiments, points about a certain threshold of error may be labeled as outliers. Outliers may be determined based on statistical thresholds or confidences—for example, if a particular firmware revision has a high rate of error that indicates its behavior is greater than two standard deviations beyond what is expected, then the particular firmware revision may be flagged as having anomalous behavior.

In various embodiments, the one or more anomaly detect modules 150 flag outliers that are detected by the machine-learning models. Outliers may be flagged based on specific time intervals over which a firmware revision behaves anomalously. In some embodiments, a time series is generated for each CPE firmware revision encoding each day that anomalous behavior is detected. For example, the time series for well-behaving CPE firmware revisions may be an empty set, indicating that no anomalies were detected for that CPE firmware revision.

In some embodiments, the one or more anomaly detection modules apply 162 additional logic to control for outliers. Additional logic may be used to perform a smoothing function and avoid false positives, intermittent or transient anomalies that may difficult to diagnose or are unrepeatable, and so on. For example, the additional logic referred to herein may comprise a pruning step where the time series of flagged outliers is inspected; when an anomaly is detected on a particular day, the adjacent days may be checked to see whether the anomaly is persistent or transient. For example, a requirement may be for anomalies to be detected on 2-of-3 consecutive days, 3-of-5 consecutive days, or other measures to avoid marking a “one hit wonder” as an anomaly that may not be a reproducible error.

In one or more embodiments, system outages or impairments may occur at many locations. For example, an outage or impairment may be system-wide, market-wide, or at the node level. In particular, MSOs and other service providers may provide service to a variety of CPE, where many CPE may be in communication with a respective node (e.g., the node 106), and the system 100 may include many nodes. There may be many different CPE models with different firmware revisions on a network. For example, a node may provide service to all the CPE of a neighborhood. Fiber optics and other connections (e.g., connections 170) may deliver data to one or more nodes, and coaxial cable or other connections (e.g., connections 172) may deliver the data the “last mile” from the nodes to the CPE. The connections 170 may include wired and/or wireless connections according to DOCSIS, optical connections, and the like.

Outages at different CPE at one node or across multiple nodes may be related. For example, a service outage that affects CPE serviced by the node 106 also may affect CPE serviced by the node 108 and/or any other nodes. In some cases, the outage or impairment may be caused by the connections 170, the headend 102 and/or the headend 104, etc. However, in other cases, the outage or impairment may be related to a CPE firmware revision shared by the affected CPE.

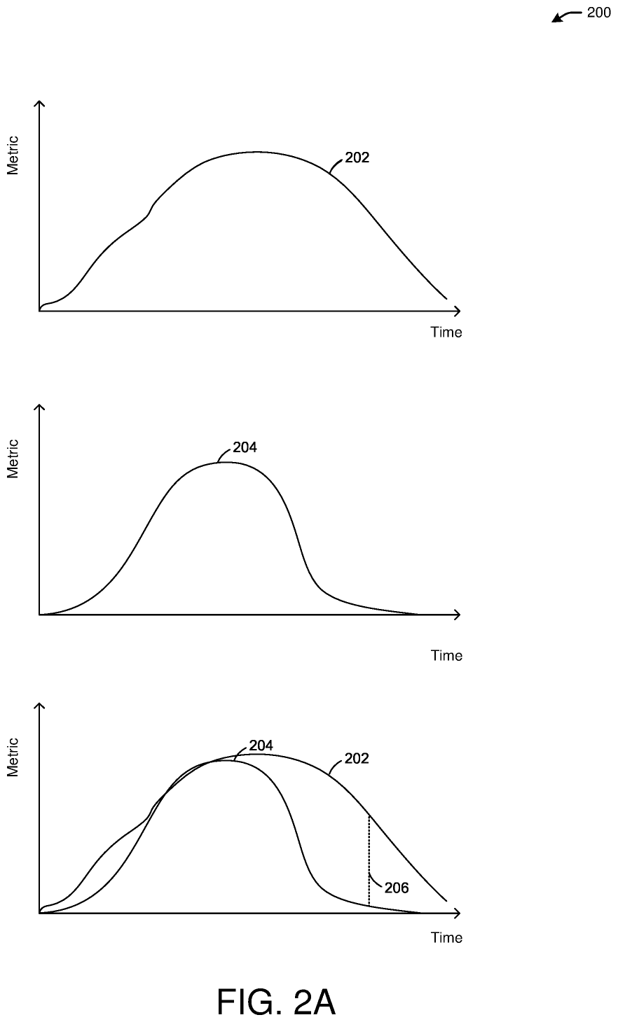

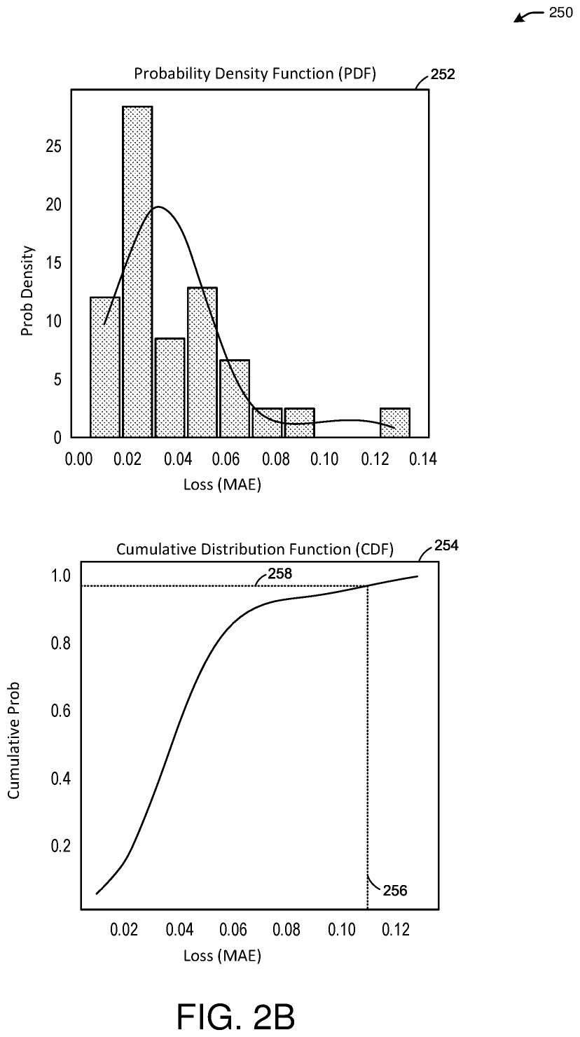

In one or more embodiments, the one or more anomaly detection modules 150 may include devices, systems, modules, and the like for analyzing data collected from the CPE, the nodes, and/or the head-ends (e.g., using wired and/or wireless connections). The one or more anomaly detection modules 150 may be scheduled to perform anomaly detection on a recurring basis, or in response to certain network conditions. For example, the outage detection systems 152 may adjust the thresholds shown in FIGS. 2A and 2B using machine learning over time.

FIG. 2A illustrates example graphs 200 of metrics evaluated by the one or more anomaly detection modules 150 of FIG. 1, in accordance with one or more embodiments of the present disclosure.

Referring to FIG. 2A, multiple graphs are shown, representing a variety of performance metrics monitored for the system 100 of FIG. 1. For example, the metrics may include call volume, number or percentage of CPE whose connections have been lost during a time period, number or percentage of nodes whose connections have been lost during a time period, or the like. The metrics shown in FIG. 2A may be any suitable metric, such as those described above in connection with FIG. 1. For example, in at least one embodiment, the metrics may correspond to any of the ETL target metrics described above.

FIG. 2A depicts illustrations 200 including an example graph 202, according to at least one embodiment. Graph 202 may represent metrics record for a CPE firmware revision over a time window. For example, the time window may be a 3-month time window or any other suitable time window over which a time series analysis may be performed. The metric represented along the Y-axis may be any suitable metric, such as those described in connection with FIG. 1. For example, the Y-axis may be one of interactive voice response (IVR) session data; calls handled data; and truck schedule data. While graph 202 is illustrated to depict the change of a metric over time, other graphs may be used to conceptualize or represent the behavior of a CPE firmware revision, for example, multi-dimensional graphs with two or more metrics plotted against time. Graph 202 illustrates an example of historical metric data over a period of time. Graph 202 may be generated from metrics of a specific firmware version of a CPE model.

FIG. 2A also illustrates an example graph 204, according to at least one embodiment. Graph 204 may be generated based at least in part on a trained machine-learning model such as an autoencoder. In at least one embodiment, metrics for all firmware revisions of a CPE model are used to generate an autoencoder and the autoencoder generates graph 204 based on metrics from a specific CPE firmware version (e.g., metrics for the CPE firmware revision illustrated in graph 202. Accordingly, graph 204 may serve as a baseline or expected metrics time series for a specific firmware revision of a CPE model based on aggregate metrics collected across all firmware revisions of the CPE model.

FIG. 2A also illustrates, at the bottom third, graph 202 and graph overlaid on top of each other depicting a fit between the actual firmware data and the mode predictions. A loss may be calculated based on differences between the actual and expected metric values to determine how good of a fit the model is for each CPE firmware revision. The difference 206 between the actual and expected value may be calculated point-for-point. In some embodiments, a loss function is calculated using mean absolute error (MAE) which may refer to the absolute difference between target and predicted variables. The MAE loss measures the average magnitude of errors across a set of predictions without regard to the direction of the difference (e.g., whether the prediction is higher or lower than the actual metrics). While MAE is described as a measurement of loss, other loss functions may be utilize, such as mean square error (MSE) Huber loss, and more. Losses across each firmware revision of a CPE model may be used to identify outliers, for example, as described below in connection with FIG. 2B.

FIG. 2B depicts illustrations 250 of example graphs 252 and 254 of metrics evaluated by the one or more anomaly detection modules 150 of FIG. 1, in accordance with one or more embodiments of the present disclosure.

Referring to FIG. 2B, multiple graphs are shown, representing aggregate statistics collected across multiple CPE firmware revisions using a model, for the system 100 of FIG. 1. For example, the metrics may include call volume, number or percentage of CPE whose connections have been lost during a time period, number or percentage of nodes whose connections have been lost during a time period, or the like. The graphs shown in FIG. 2B represent the fit of the machine-learning model for a CPE model across all firmware revisions of the CPE model, according to at least one embodiment.

In FIG. 2B, graph 254 illustrates an example probability density function for a plurality of firmware revisions of a CPE model. In various embodiments, multiple firmware revisions of a CPE model are supported on a network, and metrics for each firmware revision are collected. These metrics are used to generate a CPE model-specific autoencoder machine-learning model, according to an embodiment. Continuing, predictions generated by the model may be compared against the actual metrics collected for each CPE firmware revision to determine how good of a fit the model is for each respective CPE firmware revision. In various embodiments, the fit is determined by computing a loss, which may be based on computed as mean absolute error (MAE), mean square error (MSE), Huber loss, or any other suitable loss function that may be used to determine how well a prediction model fits actual data. The loss for each CPE firmware revision may be computed and plotted as a probability density function, as depicted in graph 252. Each bar depicted in graph 252 may correspond to how many firmware revisions had computed losses that fell in the band. For example, graph 252 depicts approximately 12 CPE firmware revisions having a computed MAE loss of between 0.00 and 0.02, approximately 28 CPE firmware revision having a computed MAE loss of between 0.02 and 0.04, and so on. The loss (e.g., MAE loss) for each CPE firmware revision may be computed and included into an appropriate bucket in graph 252. Based on the collected loss results for the plurality of CPE firmware revisions, a curve 254 may be generated as an approximate probability density function representing a continuous probability density function (PDF) for the expected loss. The PDF curve 254 may be a chi-square distribution generated based on the MAE loss of the plurality of CPE firmware revisions.

Graph 254 depicts, according to at least one embodiment, a cumulative distribution function (CDF) depicting the cumulative probabilities as a function of loss (e.g., MAE loss). As discussed above, MAE loss is merely an illustrative example of one type of loss that can be used and other losses may be computed in accordance with other embodiments not depicted in FIG. 2B. The CDF curve may be generated as the area under the PDF curve of graph 252. In various embodiments, a threshold 256 is selected based on the CDF values. For example, the threshold 256 may be set to be the loss that corresponds to a particular probability value 258, for example, the loss at a CDF of 99% or any other suitable probability, such as two standard deviations (approx. 95.45%), three standard deviations (approx. 99.73%), etc. As depicted in FIG. 2B, it may be the case that the threshold is selected at a probability value that identifies the threshold MAE loss as approximately 0.11, which is illustrated here for the same of example and not to be construed as limiting. Continuing with this example, once the outlier threshold 256 has been established, outlier CPE firmware revisions may be identified. For example, as can be seen in graph 254, there are approximately two CPE firmware revisions with MAE loss values between 0.12 and 0.14—these values exceed the example's outlier threshold that is depicted as being approximately 0.11 in graph 254. Accordingly, the firmware revisions associated with these high MAE loss values may be flagged as potential outliers.

FIGS. 2A and 2B illustrate examples in which outliers may be detected over a time series. In various embodiments, the techniques described in connection with FIGS. 2A and 2B are applied across several different CPE models, each of which have multiple supported CPE firmware revisions emitting data that is collected at metrics data stores 152 of FIG. 1. Outliers may be computed and flagged over a time window—for example, the past three months or 90 days—and outlier behavior may be identified at a per-day granularity or any other suitable granularity (e.g., hourly, etc.).

In various embodiments, flagging a CPE firmware revision as an outlier may be accomplished through writing data to a file or data object. The outlier information may indicate which dates or time intervals a particular CPE firmware revision behaves as an outlier (e.g., using techniques described above). In various embodiments, it is possible for a CPE firmware revision to behave anomalously over a first time interval but then fall back below the outlier threshold over a second time interval. Accordingly, in various embodiments, additional logic controls for outlier behavior. For example, a requirement may be for anomalies to be detected on 2-of-3 consecutive days, 3-of-5 consecutive days, or other measures to avoid marking a “one hit wonder” as an anomaly that may not be a reproducible error. Accordingly, in some cases, time periods that were initially flagged as being potentially anomalous may be discarded if the additional logic is not satisfied.

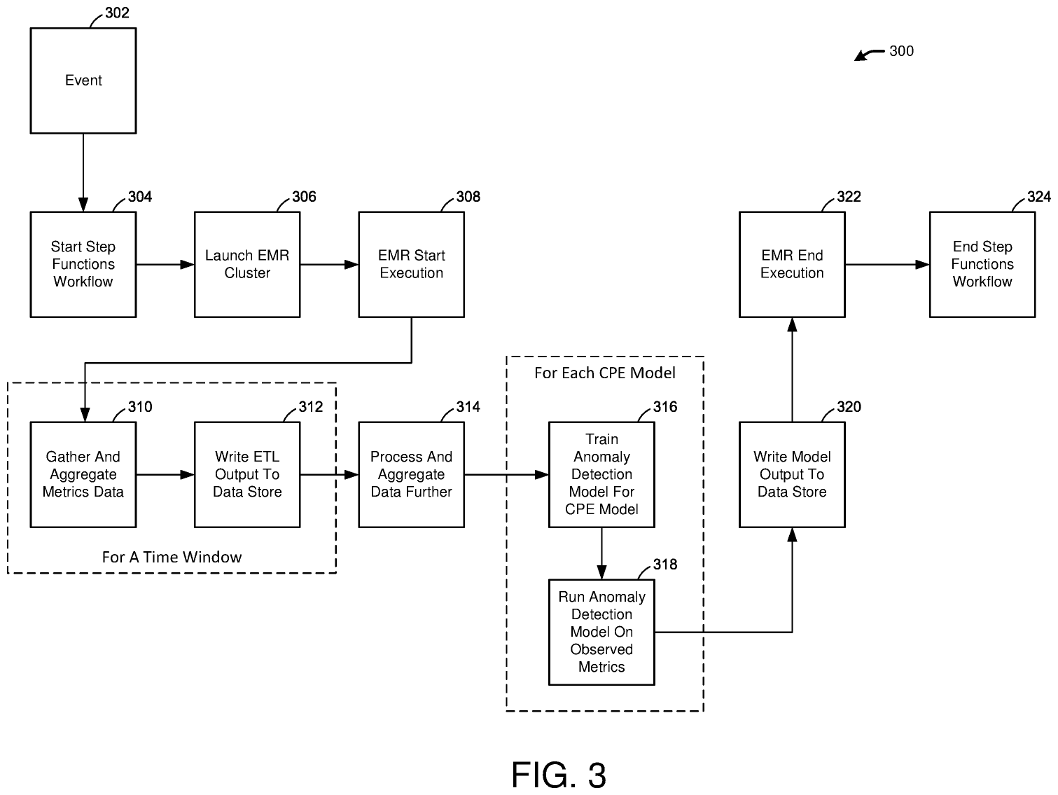

FIG. 3 illustrates an example computing environment 300 in which anomaly detection of CPE firmware revisions may be implemented, according to at least one embodiment. The computing environment 300 may be implemented at least in part in the context of a computing resource service provider (e.g., cloud provider). It should be noted that the computing environment 300 depicted in FIG. 3 is merely an illustrative example and that other environments may also be suitable for implementing techniques for anomaly detection of CPE firmware revisions.

In various embodiments, environment 300 includes a metrics monitoring service that may implement various functionality, such as event-driven compute. For example, an event 302 may be emitted on a periodic basis (e.g., every day) or in response to an event (e.g., IVR session rate exceeding a predetermined threshold). Regardless, the signaling of one or more events or types of events may be a trigger for execution of a processing flow. The event or events may trigger the execution of the start 304 of a step functions workflow.

A step functions workflow may be implemented as a state machine with a set of states that correspond to serverless compute functions and edges that are used to coordinate execution of the serverless compute functions to perform a larger workflow. For example, successful execution of one serverless compute function may cause a state machine transition that causes execution of another serverless compute function. A step functions workflow may correspond to a workflow that aggregates daily metrics, processes the aggregated data to make it model-ready, generates CPE model-specific machine-learning models, runs anomaly detection using the model on observations, flags potential outliers, applies additional logic, and combinations thereof.

In various embodiments, the start 304 of a step functions workflow comprises a step to launch 306 a cluster of resources. In some embodiments, launching a cluster involves using a serverless compute function to provision resources. A managed cluster platform may be used to coordinate the allocation and provisioning of resources for the workflow. In various embodiments, once a cluster of resources is ready, execution is started 308, which may include some or all of steps 310-320 depicted in FIG. 3. At the start, source data may be gathered and aggregated across a time window 310. The time window may be a customer-configurable setting where a customer can specify whether to perform anomaly detection using a 90-day, 3-month, 1-month, 1-week, etc. lookback window. In some embodiments, the window may be a parameter that is selected by the machine-learning model based on a determination of a suitable time window that maximizes accuracy of the model. In some embodiments, the source data is transformed from a source data format to a target data format. For example, an extract, transform, load (ETL) procedure may shape the data for modelling. The ETL output may be written to a data store 312, for example, by using an object data storage service of the cloud service provider. In various embodiment, ETL output data is processed and aggregated 314 further to make the data model-ready. The additional processing and aggregating may involve shaping the data so that it is model-ready to be used to train the autoencoder, for example, by formatting the data into columns and rows according to an ETL target format, for example, as described above in connection with FIG. 1. In some embodiments, outliers of the time window are detected and exclude from use in training by computing average time series of a CPE's firmware together to create a baseline and identify outliers (e.g., >3 standard deviations).

In various embodiments, once the data is model-ready, the ETL target data may be used to train an anomaly detection model for CPE model 316. The anomaly detection model may refer to an autoencoder. An autoencoder may be trained for each CPE model that was found in the metrics data collected over the time window. Training may be performed on a per-CPE model basis. In some embodiments, training may be performed on a per CPE-vendor basis or other criteria that provides a suitable level of generality where it is expected that all firmware revisions under the common trait behave similarly.

In various embodiments, anomaly detection is run based on observed metrics 318 to determine whether any CPE firmware revisions behave anomalously. A CPE firmware revision anomaly may be detected when a particular firmware revision behaves differently from other firmware revisions beyond a statistical threshold. For example, outlier probabilities may be computed to determine a 99% outlier threshold and any CPE firmware revisions with a loss (e.g., MAE loss) that exceeds the outlier threshold are flags as outliers. In various embodiments, outlier data is recorded to a data store object or database. The workflow may include a step to write model output to data store 320. The output may be in the form of a time series that identifies each day in which a CPE firmware revision behaves anomalously. Additional logic may be applied to prune outliers—for example, by discarding outliers that do not meet a 2-of-3 or 3-of-5 adjacency requirement. This additional logic may be optional and omitted, according to some embodiments. Upon completion, the EMR execution is ended 322 and the cluster resources may be de-allocated or de-provisioned and made available for use by other workflows within a cloud service provider. This may park the end 324 of the step functions workflow. Upon completion of the step functions workflow, a notification or second event may be emitted that indicates to the customer that the anomaly detection workflow was executed, results of the workflow, and so on. In some embodiments, the results may be post-processed and anomalous CPE firmware revisions may be surfaced. For example, service tickets may be automatically generated for CPE firmware revisions that exhibit a high tendency for anomalous behavior (e.g., 3-of-3 or 5-of-7) so that additional resources may be deployed to investigate the source of the anomaly and that an appropriate mitigate may be implemented.

Anomaly detection may be performed for every CPE firmware revision included in the collected metrics. Once all anomalies have been flagged on additional logic (if applicable) is executed to prune the outliers, the results may be stored in a database to allow for a client to retrieve and review the results, sent to client via email, and so on. EMR execution may end at this point, and the step functions workflow may complete by de-provisioning resources that were used by the step functions workflow to perform anomaly detection of CPE firmware revisions.

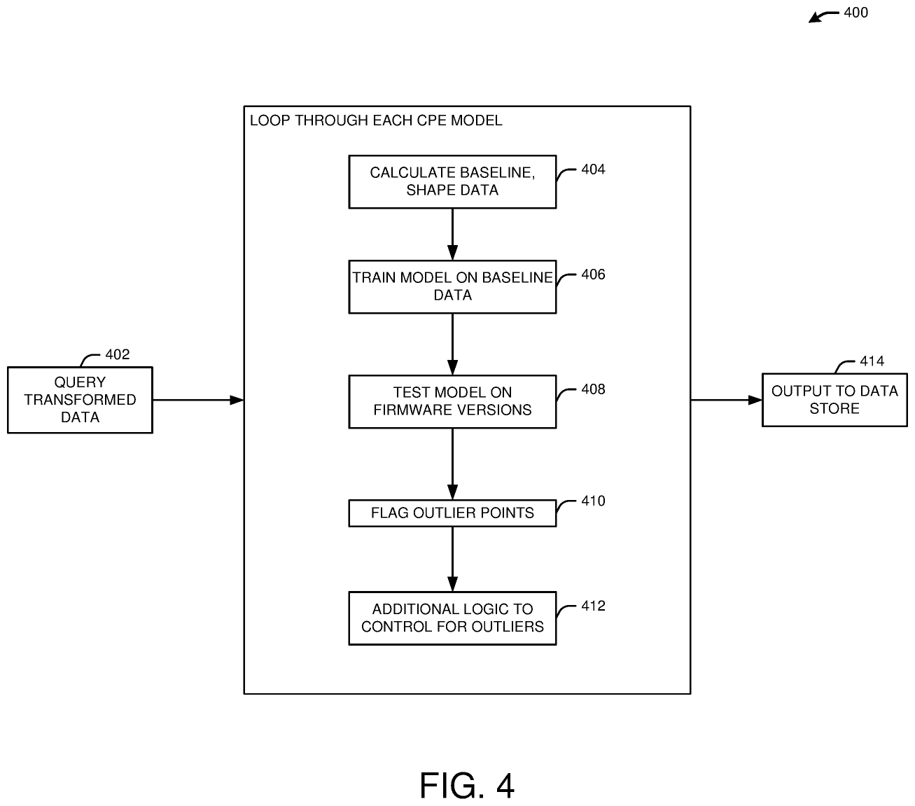

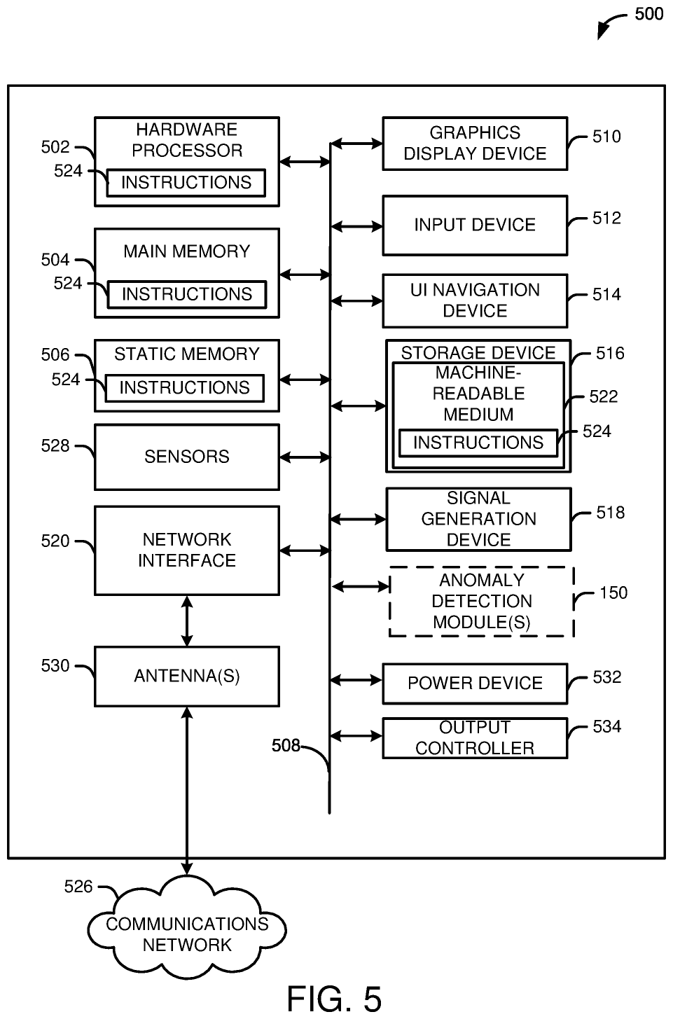

FIG. 4 shows an illustrative example of a process 400 for anomaly detection of CPE firmware revisions, in accordance with one or more example embodiments of the present disclosure. In at least one embodiment, some or all of the process 400 (or any other processes described herein, or variations and/or combinations thereof) is performed under the control of one or more computer systems that store computer-executable instructions and may be implemented as code (e.g., computer-executable instructions, one or more computer programs, or one or more applications) executing collectively on one or more processors, by hardware, software, or combinations thereof. The code, in at least one embodiment, is stored on a computer-readable storage medium in the form of a computer program comprising a plurality of computer-readable instructions executable by one or more processors. The computer-readable storage medium, in at least one embodiment, is a non-transitory computer-readable medium. In at least one embodiment, at least some of the computer-readable instructions usable to perform the process 400 are not stored solely using transitory signals (e.g., a propagating transient electric or electromagnetic transmission). A non-transitory computer-readable medium does not necessarily include non-transitory data storage circuitry (e.g., buffers, caches, and queues) within transceivers of transitory signals. Process 400 may be implemented in the context of various systems and methods described elsewhere in this disclosure, such as those discussed in connection with FIGS. 1 and 5. In at least one embodiment, process 400 or a portion thereof is implemented using an anomaly detection module, such as those described in connection with FIG. 1.

A system performing process 400 may perform a step to query 402 transformed data. Transformed data may be generated by obtaining source data from one or more metrics data stores such as those described in connection with FIG. 1 and perform an extract, transform, and load (ETL) procedure on the data. In some embodiments, CPE and/or firmware revision counts are obtained from source data. The source data may be aggregated by date and/or MAC. The processing workflow may furthermore join product and customer id number (e.g., customer key) on MAC. A join of various metrics of interest on customer id number (e.g., customer key) may then be performed. For example, a join of interactive voice response (IVR) session data; calls handled data; and trucks data may be joined on customer id number (e.g., customer key) to produce a final table that is aggregated by date, vendor, model, and firmware version. The final table may be saved to a data store or database so that a suitable system, such as anomaly detection module, is able to query 402 the transformed data.

A system performing process 400 may perform a step to calculate 404 baseline, shape data. In various embodiments, this step involves logic to process and aggregate data and/or to make the transformed data model-ready. Model-ready data may refer to data with features aggregated at the level of date and firmware. In various embodiments, the model-ready data is stored in a table organized in columns or fields and may include one or more of (including combinations of): date/time of record (e.g., event); site identifier or information; node identifier; CPE vendor; CPE mode; CPE firmware version; product type (e.g., whether the product is used for data, video, telephone, or other network functionality); cable modem termination system (CMTS) reset information; loss of synchronization between CMTS and device information; t1 error information (e.g., modem has not received upstream channel descriptor); t2 error information (e.g., modem did not receive broadcast maintenance opportunity); t3 error information (e.g., modem has sent ranging requests but not received ranging response from CMTS); t4 error information (e.g., modem has not received broadcast maintenance opportunity in which to transmit ranging request); count of devices on network; count of IVR transactions; count of calls handled; count of tech support home technician trucks scheduled; count of tech support home technician trucks rolled to customer. The model-ready data or a portion thereof may be used as baseline data. In some embodiments, average time series of a CPE's firmware together create a baseline. In some cases, outliers (e.g., >3 standard deviations) may be excluded.

A system performing process 400 may perform a step to train 406 model on baseline data. As discussed above, the baseline data may be aggregated by date and firmware. The model may be an autoencoder that is trained in an unsupervised manner. In various embodiments, baseline data for all firmware revisions of a particular CPE model may be used to train an autoencoder. In some embodiments, some firmware revisions (e.g., outliers) may be excluded from training.

A system performing process 400 may perform a step to test 408 the trained model on firmware revisions. Trained autoencoders may be used to test whether specific firmware revisions for a CPE model exhibit anomalous behavior using the CPE model-specific autoencoder. Testing firmware revisions may involve a model fitting process where trained models are fit to firmware data (e.g., test data). Firmware revisions with a bad fit will have observed values with high error relative to the model's predictions. In various embodiments, points about a certain threshold of error may be labeled as outliers. Outliers may be determined based on statistical thresholds or confidences—for example, if a particular firmware revision has a high rate of error that indicates its behavior is greater than two standard deviations beyond what is expected, then the particular firmware revision may be flagged as having anomalous behavior.

A system performing process 400 may perform a step to flag 410 outlier points. Outlier points may be flagged for various CPE firmware revisions by computing mean absolute error (MAE) losses for each CPE firmware revision as compared against the model. In various embodiments, a probability density function or curve is determined based on these computed losses. The PDF may be used to determine a CDF to determine an outlier threshold. The outlier threshold may refer to the MAE loss value that corresponds to a particular CDF percentile, such as the 99^{th} percentile, 99.5^{th} percentile, or any other suitable percentile for identifying anomalous behavior. CPE firmware revisions that exceed the outlier threshold may be flagged as outliers. A time series may be generated for each CPE firmware revision—an empty time series may correspond to a well-behaving CPE firmware revision with no detected anomalous behavior. Testing of firmware versions may indicate that a firmware revision exhibits anomalous behavior on some days but not others. This changing behavior over time may be represented as a time series.

A system performing process 400 may perform a step to perform additional logic 412 to control for outliers. In some embodiments, the additional logic prunes the time series of outlier points and smooths out the anomalies. For example, if anomalous behavior is detected on only one day over an extended time window (e.g., 3 months) it may be unhelpful to surface the anomaly or there may be lower confidence, statistically speaking, that the firmware revision has a problem. In some embodiments, outliers are retained if they are in close temporal proximity to other outliers. For example, if 2-of-3 days are outliers, then the outliers may be retained; else, the outliers are discarded as isolated cases.

In various embodiments, steps 402-410 are performed in a loop for each CPE model identified in a transformed data set. The results for each of these iterations may be written as outputs to a data store, which may be hosted on an object data storage service hosted by a cloud service provider.

In various embodiments, the system performing process 400 comprises a step to output 414 the results to a data store such as an object data store of a cloud service provider. The output data may be in the form of time series that mark the dates over which various CPE firmware revisions were detected to exhibit anomalous behavior. Mitigations may be taken based on the output data. For example, recent anomalous behavior detected in a CPE firmware revision may indicate a breaking change related to the CPE firmware revision or changes in network conditions that adversely affect that specific CPE firmware revision but no other revisions. Devices with such a CPE firmware revision may be updated to a newer firmware revision or may be rolled back to an older version, wherein the update version is verified to not exhibit the anomalous behavior that is being mitigated through the update.

It is understood that the above descriptions are for purposes of illustration and are not meant to be limiting.

FIG. 5 illustrates a block diagram of an example of a machine 500 (e.g., the one or more anomaly detection modules 150 of FIG. 1, the outage detection systems of FIG. 1) or system upon which any one or more of the techniques (e.g., methodologies) discussed herein may be performed. In other embodiments, the machine 500 may operate as a standalone device or may be connected (e.g., networked) to other machines. In a networked deployment, the machine 500 may operate in the capacity of a server machine, a client machine, or both in server-client network environments. The machine 500 may be a wearable device or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), or other computer cluster configurations.

Examples, as described herein, may include or may operate on logic or a number of components, modules, or mechanisms. Modules are tangible entities (e.g., hardware) capable of performing specified operations when operating. A module includes hardware. In an example, the hardware may be specifically configured to carry out a specific operation (e.g., hardwired). In another example, the hardware may include configurable execution units (e.g., transistors, circuits, etc.) and a computer readable medium containing instructions where the instructions configure the execution units to carry out a specific operation when in operation. The configuring may occur under the direction of the executions units or a loading mechanism. Accordingly, the execution units are communicatively coupled to the computer-readable medium when the device is operating. In this example, the execution units may be a member of more than one module. For example, under operation, the execution units may be configured by a first set of instructions to implement a first module at one point in time and reconfigured by a second set of instructions to implement a second module at a second point in time.

The machine (e.g., computer system) 500 may include any combination of the illustrated components. For example, the machine 500 may include a hardware processor 502 (e.g., a central processing unit (CPU), a graphics processing unit (GPU), a tensor processing unit (TPU) including an artificial intelligence application-specific integrated circuit (ASIC), a hardware processor core, or any combination thereof), a main memory 504 and a static memory 506, some or all of which may communicate with each other via an interlink (e.g., bus) 508. The machine 500 may further include a power management device 532, a graphics display device 510, an alphanumeric input device 512 (e.g., a keyboard), and a user interface (UI) navigation device 514 (e.g., a mouse). In an example, the graphics display device 510, alphanumeric input device 512, and UI navigation device 514 may be a touch screen display. The machine 500 may additionally include a storage device (i.e., drive unit) 516, a signal generation device 518 (e.g., a data signal), the one or more anomaly detection modules 150 of FIG. 1, a network interface device/transceiver 520 coupled to antenna(s) 530, and one or more sensors 528, such as a sound detecting sensor (e.g., a microphone), accelerometers, magnetometers, location sensors, and the like. The machine 500 may include an output controller 534, such as a serial (e.g., universal serial bus (USB), parallel, or other wired or wireless (e.g., infrared (IR), near field communication (NFC), etc.) connection to communicate with or control one or more peripheral devices (e.g., a printer, a card reader, other sensors, etc.)).

The storage device 516 may include a machine readable medium 522 on which is stored one or more sets of data structures or instructions 524 (e.g., software) embodying or utilized by any one or more of the techniques or functions described herein. The instructions 524 may also reside, completely or at least partially, within the main memory 504, within the static memory 506, or within the hardware processor 502 during execution thereof by the machine 500. In an example, one or any combination of the hardware processor 502, the main memory 504, the static memory 506, or the storage device 516 may constitute machine-readable media.

While the machine-readable medium 522 is illustrated as a single medium, the term “machine-readable medium” may include a single medium or multiple media (e.g., a centralized or distributed database, and/or associated caches and servers) configured to store the one or more instructions 524.

Various embodiments may be implemented fully or partially in software and/or firmware. This software and/or firmware may take the form of instructions contained in or on a non-transitory computer-readable storage medium. Those instructions may then be read and executed by one or more processors to enable performance of the operations described herein. The instructions may be in any suitable form, such as but not limited to source code, compiled code, interpreted code, executable code, static code, dynamic code, and the like. Such a computer-readable medium may include any tangible non-transitory medium for storing information in a form readable by one or more computers, such as but not limited to read-only memory (ROM); random access memory (RAM); magnetic disk storage media; optical storage media; a flash memory, etc.

The term “machine-readable medium” may include any medium that is capable of storing, encoding, or carrying instructions for execution by the machine 500 and that cause the machine 500 to perform any one or more of the techniques of the present disclosure, or that is capable of storing, encoding, or carrying data structures used by or associated with such instructions. Non-limiting machine-readable medium examples may include solid-state memories and optical and magnetic media. In an example, a massed machine-readable medium includes a machine-readable medium with a plurality of particles having resting mass. Specific examples of massed machine-readable media may include non-volatile memory, such as semiconductor memory devices (e.g., electrically programmable read-only memory (EPROM), or electrically erasable programmable read-only memory (EEPROM)) and flash memory devices; magnetic disks, such as internal hard disks and removable disks; magneto-optical disks; and CD-ROM and DVD-ROM disks.

The instructions 524 may further be transmitted or received over a communications network 526 using a transmission medium via the network interface device/transceiver 520 utilizing any one of a number of transfer protocols (e.g., frame relay, internet protocol (IP), transmission control protocol (TCP), user datagram protocol (UDP), hypertext transfer protocol (HTTP), etc.). Example communications networks may include DOCSIS, fiber optic, a local area network (LAN), a wide area network (WAN), a packet data network (e.g., the Internet), mobile telephone networks (e.g., cellular networks), plain old telephone (POTS) networks, wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, and peer-to-peer (P2P) networks, among others. In an example, the network interface device/transceiver 520 may include one or more physical jacks (e.g., Ethernet, coaxial, or phone jacks) or one or more antennas to connect to the communications network 526. In an example, the network interface device/transceiver 520 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding, or carrying instructions for execution by the machine 500 and includes digital or analog communications signals or other intangible media to facilitate communication of such software.

The operations and processes described and shown above may be carried out or performed in any suitable order as desired in various implementations. Additionally, in certain implementations, at least a portion of the operations may be carried out in parallel. Furthermore, in certain implementations, less than or more than the operations described may be performed.

The word “exemplary” is used herein to mean “serving as an example, instance, or illustration.” Any embodiment described herein as “exemplary” is not necessarily to be construed as preferred or advantageous over other embodiments. The terms “computing device,” “user device,” “communication station,” “station,” “handheld device,” “mobile device,” “wireless device,” and “user equipment” (UE) as used herein refers to a wireless communication device such as a cable box, a wearable smart device, cellular telephone, a smartphone, a tablet, a netbook, a wireless terminal, a laptop computer, a femtocell, a high data rate (HDR) subscriber station, an access point, a printer, a point of sale device, an access terminal, or other personal communication system (PCS) device. The device may be either mobile or stationary.

As used within this document, the term “communicate” is intended to include transmitting, or receiving, or both transmitting and receiving. This may be particularly useful in claims when describing the organization of data that is being transmitted by one device and received by another, but only the functionality of one of those devices is required to infringe the claim. Similarly, the bidirectional exchange of data between two devices (both devices transmit and receive during the exchange) may be described as “communicating,” when only the functionality of one of those devices is being claimed. The term “communicating” as used herein with respect to a wireless communication signal includes transmitting the wireless communication signal and/or receiving the wireless communication signal. For example, a wireless communication unit, which is capable of communicating a wireless communication signal, may include a wireless transmitter to transmit the wireless communication signal to at least one other wireless communication unit, and/or a wireless communication receiver to receive the wireless communication signal from at least one other wireless communication unit.

As used herein, unless otherwise specified, the use of the ordinal adjectives “first,” “second,” “third,” etc., to describe a common object, merely indicates that different instances of like objects are being referred to and are not intended to imply that the objects so described must be in a given sequence, either temporally, spatially, in ranking, or in any other manner.

Some embodiments may be used in conjunction with various devices and systems, for example, a wearable smart device, a personal computer (PC), a desktop computer, a mobile computer, a laptop computer, a notebook computer, a tablet computer, a server computer, a handheld computer, a handheld device, a personal digital assistant (PDA) device, a handheld PDA device, an on-board device, an off-board device, a hybrid device, a vehicular device, a non-vehicular device, a mobile or portable device, a consumer device, a non-mobile or non-portable device, a wireless communication station, a wireless communication device, a wireless access point (AP), a wired or wireless router, a wired or wireless modem, a video device, an audio device, an audio-video (A/V) device, a wired or wireless network, a wireless area network, a wireless video area network (WVAN), a local area network (LAN), a wireless LAN (WLAN), a personal area network (PAN), a wireless PAN (WPAN), and the like.

Some embodiments may be used in conjunction with one way and/or two-way radio communication systems, cellular radio-telephone communication systems, a mobile phone, a cellular telephone, a wireless telephone, a personal communication system (PCS) device, a PDA device which incorporates a wireless communication device, a mobile or portable global positioning system (GPS) device, a device which incorporates a GPS receiver or transceiver or chip, a device which incorporates an RFID element or chip, a multiple-input multiple-output (MIMO) transceiver or device, a single input multiple output (SIMO) transceiver or device, a multiple-input single-output (MISO) transceiver or device, a device having one or more internal antennas and/or external antennas, digital video broadcast (DVB) devices or systems, multi-standard radio devices or systems, a wired or wireless handheld device, e.g., a smartphone, a wireless application protocol (WAP) device, or the like.

Some embodiments may be used in conjunction with one or more types of wireless communication signals and/or systems following one or more wireless communication protocols, for example, DOCSIS, radio frequency (RF), infrared (IR), frequency-division multiplexing (FDM), orthogonal FDM (OFDM), time-division multiplexing (TDM), time-division multiple access (TDMA), extended TDMA (E-TDMA), general packet radio service (GPRS), extended GPRS, code-division multiple access (CDMA), wideband CDMA (WCDMA), CDMA 2000, single-carrier CDMA, multi-carrier CDMA, multi-carrier modulation (MDM), discrete multi-tone (DMT), Bluetooth®, global positioning system (GPS), Wi-Fi, Wi-Max, ZigBee, ultra-wideband (UWB), global system for mobile communications (GSM), 2G, 2.5G, 3G, 3.5G, 4G, fifth-generation (5G) mobile networks, 3GPP, long term evolution (LTE), LTE advanced, enhanced data rates for GSM Evolution (EDGE), or the like. Other embodiments may be used in various other devices, systems, and/or networks.

Embodiments according to the disclosure are in particular disclosed in the attached claims directed to a method, a storage medium, a device and a computer program product, wherein any feature mentioned in one claim category, e.g., method, can be claimed in another claim category, e.g., system, as well. The dependencies or references back in the attached claims are chosen for formal reasons only. However, any subject matter resulting from a deliberate reference back to any previous claims (in particular multiple dependencies) can be claimed as well, so that any combination of claims and the features thereof are disclosed and can be claimed regardless of the dependencies chosen in the attached claims. The subject-matter which can be claimed comprises not only the combinations of features as set out in the attached claims but also any other combination of features in the claims, wherein each feature mentioned in the claims can be combined with any other feature or combination of other features in the claims. Furthermore, any of the embodiments and features described or depicted herein can be claimed in a separate claim and/or in any combination with any embodiment or feature described or depicted herein or with any of the features of the attached claims.

The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Certain aspects of the disclosure are described above with reference to block and flow diagrams of systems, methods, apparatuses, and/or computer program products according to various implementations. It will be understood that one or more blocks of the block diagrams and flow diagrams, and combinations of blocks in the block diagrams and the flow diagrams, respectively, may be implemented by computer-executable program instructions. Likewise, some blocks of the block diagrams and flow diagrams may not necessarily need to be performed in the order presented, or may not necessarily need to be performed at all, according to some implementations.

These computer-executable program instructions may be loaded onto a special-purpose computer or other particular machine, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable storage media or memory that may direct a computer or other programmable data processing apparatus to function in a particular manner, such that the instructions stored in the computer-readable storage media produce an article of manufacture including instruction means that implement one or more functions specified in the flow diagram block or blocks. As an example, certain implementations may provide for a computer program product, comprising a computer-readable storage medium having a computer-readable program code or program instructions implemented therein, said computer-readable program code adapted to be executed to implement one or more functions specified in the flow diagram block or blocks. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions, and program instruction means for performing the specified functions. It will also be understood that each block of the block diagrams and flow diagrams, and combinations of blocks in the block diagrams and flow diagrams, may be implemented by special-purpose, hardware-based computer systems that perform the specified functions, elements or steps, or combinations of special-purpose hardware and computer instructions.

Conditional language, such as, among others, “can,” “could,” “might,” or “may,” unless specifically stated otherwise, or otherwise understood within the context as used, is generally intended to convey that certain implementations could include, while other implementations do not include, certain features, elements, and/or operations. Thus, such conditional language is not generally intended to imply that features, elements, and/or operations are in any way required for one or more implementations or that one or more implementations necessarily include logic for deciding, with or without user input or prompting, whether these features, elements, and/or operations are included or are to be performed in any particular implementation.

Many modifications and other implementations of the disclosure set forth herein will be apparent, having the benefit of the teachings presented in the foregoing descriptions and the associated drawings. Therefore, it is to be understood that the disclosure is not to be limited to the specific implementations disclosed and that modifications and other implementations are intended to be included within the scope of the appended claims. Although specific terms are employed herein, they are used in a generic and descriptive sense only and not for purposes of limitation.

What is claimed is:

1. A system comprising:
at least one processor; and
at least one memory storing computer-executable instructions, that when executed by the at least one processor, cause the at least one processor to:
collect metrics data for a plurality of customer-provided equipment (CPE) models over a window of time, wherein the metrics data comprises one or more of:
interactive voice response (IVR) session data;
calls handled data; and
truck schedule data;
train a first autoencoder for a first CPE model of the plurality of CPE models using at least a portion of the metrics data to detect anomalies within a plurality of firmware versions of the first CPE model;
identify, using the first autoencoder, that a first firmware version of the plurality of firmware versions is anomalous across a first time series; and
store data indicating that the first firmware version of the plurality of firmware versions is anomalous across the first time series.

2. The system of claim 1, wherein the instructions to identify, using the first autoencoder, that the first firmware version of the plurality of firmware versions is anomalous across the first time series comprises instructions that, when executed by the at least one processor, cause the at least one processor to:
determine, for a first time of the time series, losses of the plurality of firmware versions computed using the first autoencoder;
determine, based on the losses, a probability density function (PDF) for the plurality of firmware versions;
determine, based on the PDF, a cumulative distribution function (CDF);
determine an outlier threshold based on the CDF and a predetermined probability; and
determine that loss of the first firmware version exceeds the outlier threshold.

3. The system of claim 2, wherein the loss is a mean absolute error loss.

4. The system of claim 1, wherein the instructions include further instructions that when executed by the at least one processor, cause the at least one processor to further:
analyze the metrics data to identify one or more firmware versions of the first CPE model whose metrics data are outliers; and
exclude the metrics data of the one or more firmware versions from the at least portion of the metrics data used to train the first autoencoder.

5. The system of claim 1, wherein the instructions include further instructions that when executed by the at least one processor, cause the at least one processor to further:
determine a first date in the first time series; and
determine that a second date within a three-day time window of the first date is also included in the first time series.

6. The system of claim 1, wherein the instructions include further instructions that when executed by the at least one processor, cause the at least one processor to further:
train, for a second CPE model of the plurality of CPE models, a second autoencoder using at least the portion of the metrics data;
determine a second plurality of firmware versions of the second CPE model;
identify, using the second autoencoder, that a second firmware version of the second plurality of firmware versions is anomalous across a second time series; and
store second data indicating that the second firmware version of the second plurality of firmware versions is anomalous across the second time series.

7. The system of claim 1, wherein the first time series comprises two non-contiguous segments.

8. A method, comprising:
collecting, by at least one processor of a device, metrics data for a plurality of customer-provided equipment (CPE) models over a window of time, wherein the metrics data comprises one or more of:
interactive voice response (IVR) session data;
calls handled data; and
truck schedule data;
training, by the at least one processor, for a first CPE model of the plurality of CPE models, a first autoencoder using at least a portion of the metrics data;
determining, by the at least one processor, a plurality of firmware versions of the first CPE model;
identifying, by the at least one processor, using the first autoencoder, that a first firmware version of the plurality of firmware versions is anomalous across a first time series; and
storing, by the at least one processor, data indicating that the first firmware version of the plurality of firmware versions is anomalous across the first time series.

9. The method of claim 8, wherein identifying, by the at least one processor, using the first autoencoder, that the first firmware version of the plurality of firmware versions is anomalous across the first time series comprises:
determining, for a first time of the time series, losses of the plurality of firmware versions computed using the first autoencoder;
determining, based on the losses, a probability density function (PDF) for the plurality of firmware versions;
determining, based on the PDF, a cumulative distribution function (CDF);
determining an outlier threshold based on the CDF and a predetermined probability; and
determine that loss of the first firmware version exceeds the outlier threshold.

10. The method of claim 9, wherein the loss is a mean absolute error loss.

11. The method of claim 8, further comprising:
analyzing the metrics data to identify one or more firmware versions of the first CPE model whose metrics data are outliers; and
excluding the metrics data of the one or more firmware versions from the at least portion of the metrics data used to train the first autoencoder.

12. The method of claim 8, further comprising:
determining a first date in the first time series; and
determining that a second date within a three-day time window of the first date is also included in the first time series.

13. The method of claim 8, further comprising:
training, for a second CPE model of the plurality of CPE models, a second autoencoder using at least the portion of the metrics data;
determining a second plurality of firmware versions of the second CPE model;
identifying, using the second autoencoder, that a second firmware version of the second plurality of firmware versions is anomalous across a second time series; and
store second data indicating that the second firmware version of the second plurality of firmware versions is anomalous across the second time series.

14. The method of claim 8, wherein the first time series comprises two non-contiguous segments.

15. A non-transitory computer-readable medium including computer-executable instructions stored thereon, which when executed by at least one processors, cause the at least one processors to:
collect metrics data for a plurality of customer-provided equipment (CPE) models over a window of time, wherein the metrics data comprises one or more of:
interactive voice response (IVR) session data;
calls handled data; and
truck schedule data;
train a first autoencoder for a first CPE model of the plurality of CPE models using at least a portion of the metrics data to detect anomalies within a plurality of firmware versions of the first CPE model;
identify, using the first autoencoder, that a first firmware version of the plurality of firmware versions is anomalous across a first time series; and
store data indicating that the first firmware version of the plurality of firmware versions is anomalous across the first time series.

16. The non-transitory computer-readable medium of claim 15, wherein the instructions to identify, using the first autoencoder, that the first firmware version of the plurality of firmware versions is anomalous across the first time series comprises instructions that, when executed by the at least one processor, cause the at least one processor to:
determine, for a first time of the time series, losses of the plurality of firmware versions computed using the first autoencoder;
determine, based on the losses, a probability density function (PDF) for the plurality of firmware versions;
determine, based on the PDF, a cumulative distribution function (CDF);
determine an outlier threshold based on the CDF and a predetermined probability; and
determine that loss of the first firmware version exceeds the outlier threshold.

17. The non-transitory computer-readable medium of claim 16, wherein the loss is a mean absolute error loss.

18. The non-transitory computer-readable medium of claim 15, wherein the instructions include further instructions that when executed by the at least one processor, cause the at least one processor to further:
analyze the metrics data to identify one or more firmware versions of the first CPE model whose metrics data are outliers; and
exclude the metrics data of the one or more firmware versions from the at least portion of the metrics data used to train the first autoencoder.

19. The non-transitory computer-readable medium of claim 15, wherein the instructions include further instructions that when executed by the at least one processor, cause the at least one processor to further:
determine a first date in the first time series; and
determine that a second date within a three-day time window of the first date is also included in the first time series.

20. The non-transitory computer-readable medium of claim 15, wherein the instructions include further instructions that when executed by the at least one processor, cause the at least one processor to further:
train, for a second CPE model of the plurality of CPE models, a second autoencoder using at least the portion of the metrics data;
determine a second plurality of firmware versions of the second CPE model;
identify, using the second autoencoder, that a second firmware version of the second plurality of firmware versions is anomalous across a second time series; and
store second data indicating that the second firmware version of the second plurality of firmware versions is anomalous across the second time series.
